(19) United States
(12) Patent Application Publication
(10) Pub. No.: US 2026/0197509 A1
(43) Pub. Date: Jul. 9, 2026

(54) MODULAR WEARABLE CAMERA WITH AI-DRIVEN VIDEO PROCESSING, LIVESTREAMING, AND MULTI-PURPOSE ATTACHMENT SYSTEM

(71) Applicant: MOORvision Technologies Inc., Glendale, CA (US)

(72) Inventors: Ali-Khan Ibragimov, Glendale, CA (US); Rashan Samad Allen, North Hollywood, CA (US)

(73) Assignee: MOORvision Technologies Inc., Glendale, CA (US)

(21) Appl. No.: 19/012,061

(22) Filed: Jan. 7, 2025

(51) Int. Cl. H04N 21/218; G06F 1/16; G06F 1/3212; G06F 1/3234; G06F 3/16; G06V 40/16; H04N 21/2187; H04N 21/2343; H04N 21/422; H04N 21/4223; H04N 21/8549

(52) U.S. Cl. CPC H04N 21/21805; G06F 1/163; G06F 1/1686; G06F 1/3212; G06F 1/325; G06F 3/167; G06V 40/172; H04N 21/2187; H04N 21/234381; H04N 21/42203; H04N 21/4223; H04N 21/8549; G06F 1/1635

(57) ABSTRACT

A camera system may include a camera that includes a front facing camera portion and a rear facing camera portion configured to be selectively coupled with the front facing camera via one or more coupling mechanisms. The camera system may include a controller configured to communicate with a streaming platform. The controller may include a video capture module configured to dynamically optimize transmission quality of the video data based on perceived bandwidth between the controller and the streaming platform and a voice command module configured to receive natural language commands and execute one or more actions to control capture of the video data based on the natural language commands.

### FIELD OF DISCLOSURE

The present disclosure generally relates to a modular wearable camera and, more particularly, to a modular wearable camera system that provides real-time or near real-time video processing and streaming technologies.

### BACKGROUND

Wearable camera devices are used across a variety of applications, from recreational activities to profession fields. Existing wearable camera technology typically provides users with hands-free video and image capture functionalities.

### SUMMARY

In some embodiments, a camera system is disclosed herein. The camera system includes a camera configured to capture video data. The camera includes a front facing camera portion, a rear facing camera portion, and a controller. The front facing camera portion includes a lens. The rear facing camera portion is configured to be selectively coupled with front facing camera via one or more coupling mechanisms. The controller is configured to communicate with a streaming platform. The controller includes a video capture module and a voice command module. The video capture module is configured to dynamically optimize transmission quality of the video data based on perceived bandwidth between the controller and the streaming platform. The voice command module is configured to receive natural language commands and execute one or more actions to control capture of the video data based on the natural language commands.

In some embodiments, a camera system is disclosed herein. The camera system includes a camera. The camera includes a front facing camera portion, a rear facing camera portion, and a controller. The front facing camera portion includes a lens. The rear facing camera portion is configured to be selectively coupled with front facing camera via one or more coupling mechanisms. The controller is configured to perform operations. The operations include receiving video data of a target of interest, identifying one or more objects in the target of interest using one or more object detection algorithms, identifying one or more subjects in the target of interest using one or more facial recognition algorithms, and dynamically adjusting parameters of the camera based on the identified one or more objects and the identified one or more subjects.

In some embodiments, a camera system is disclosed herein. The camera system includes a camera. The camera includes a front facing camera portion, a rear facing camera portion, and a controller. The front facing camera portion includes a lens. The rear facing camera portion is configured to be selectively coupled with front facing camera via one or more coupling mechanisms. The controller is configured to perform operations. The operations include receiving video data of a target of interest, identifying one or more objects in the target of interest using one or more object detection algorithms, identifying one or more subjects in the target of interest using one or more facial recognition algorithms, and generating a video segment from the video data based on the identified one or more objects and the identified one or more subjects.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 is a block diagram illustrating a computing environment, according to example embodiments.

FIG. 3 is a block diagram illustrating a computing environment, according to example embodiments.

FIG. 4 is a flow diagram illustrating a method of generating a video stream, according to example embodiments.

FIG. 5 is a flow diagram illustrating a method of generating a video stream, according to example embodiments.

FIG. 6A is a block diagram illustrating a computing device, according to example embodiments of the present disclosure.

FIG. 6B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques disclosed herein generally relate to a wearable modular camera system that includes a front camera module and a rear camera module designed to be embedded or worn on clothing. The front camera module may include at least one camera lens and connection elements that interface with corresponding components on the rear camera module. The camera system may be designed for seamless, hands-free use and may integrate with artificial intelligence driven functionalities such as video editing, highlight generation, and live streaming optimization.

In some embodiments, the one or more artificial intelligence algorithms may be configured to dynamically enhance the camera system's functionality by automatically adjusting focus, exposure, and stabilizing footage. In some embodiments, the camera system may employ facial recognition and/or object tracking technologies to ensure that the camera remains centered on key subjects. In some embodiments, the camera system may implement scene recognition algorithms to optimize camera settings based on the detected environment and activity.

In some embodiments, the camera system may enable real-time or near real-time livestreaming, with artificial intelligence optimized video quality and performance based on network conditions. In some embodiments, the camera system may further include emotion detection capabilities to allow for more contextual captures and can trigger recording based on detected emotional states.

The camera system disclosed herein generally provides a solution to the current state of camera devices that typically take the form of inflexible camera attachments that require bulky clips or other accessories. Traditional action cameras are difficult to attach and wear seamlessly, often requiring cumbersome mounts. Furthermore, existing solutions lack the integration of advanced artificial intelligence techniques for video enhancement and livestreaming, which limits their use for more dynamic activities. The artificial intelligence integrations offer real-time video optimization, including automatic scene recognition, emotion detection, and automatically generated video highlights. The real-time livestreaming features may be enhanced by artificial intelligence driven bitrate and quality adjustments, ensuring high-quality streams even under variable network conditions.

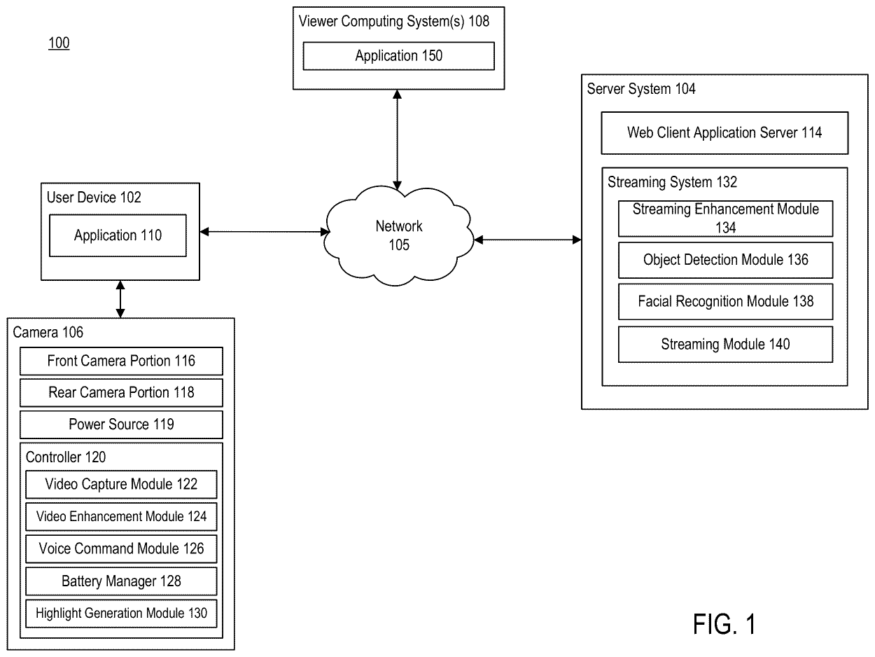

FIG. 1 is a block diagram illustrating a computing environment 100, according to example embodiments. Computing environment 100 may include user device 102, server system 104, camera 106, and viewer computing systems 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user. User device 102 may be representative of a mobile device, a tablet, a desktop computer, or any computing system having the capabilities described herein. User device 102 may include an application 110 executing thereon. Application 110 may be representative of an application associated with server system 104. For example, application 110 may be representative of a streaming application that provides the user the ability to livestream content to one or more viewer computing systems 108 and/or view content from one or more other streamers. In some embodiments, application 110 may be a standalone application associated with server system 104, such as a mobile application, tablet application, desktop application, or, more generally, a software application affiliated with an entity associated with server system 104. In some embodiments, application 110 may be representative of a web browser configured to communicate with server system 104, such that an end user may gain access to streaming system 132 of server system 104 via a web browser. More generally, application 110 may be configured to provide an interface between user device 102 and server system 104 for the purpose of allowing a user to generate streams for a desired audience or view streams from other users.

As shown, user device 102 may be in communication with camera 106. Camera 106 may be representative of a two-part module camera system designed to be worn seamlessly on clothing of the user. For example, camera 106 may be representative of the camera assembly disclosed in U.S. Pat. No. 11,714,340, which is hereby incorporated by reference in its entirety.

Camera 106 may include a front camera module 116 and a rear camera module 118. Front camera module 116 includes at least one camera lens, magnets, and connection elements. The connection elements (e.g., magnets, pins, Velcro, latches, etc.) are configured to mate or attach to rear camera module 118 positioned inside the garment. In some embodiments, front camera module 116 may further include a controller 120. Controller 120 may be representative of a general-purpose computer configured to perform various processing capabilities described herein. In some embodiments, front camera module 116 may include one or more printed circuit board stabilizing mechanisms for improved durability and reliability. The one or more printed circuit board mechanisms may be configured to stabilize controller 120 during operation.

Rear camera module 118 may include power capabilities that ensure a balanced distribution of camera's 106 core functions. For example, rear camera module may include power source 119. Power source 119 may be configured to power the controller. In some embodiments, power source 119 may be representative of an interchangeable power supply that allows users to swap between various battery options, such as, but not limited to standard, extended, or ultra-compact capacities, as well as alternative power sources such as solar cells or kinetic energy harvesters. In some embodiments, power source 119 may be charged wirelessly through magnets or wireless charging coils formed from the one or more connection elements.

Although controller 120 is shown to be included in front camera module 116, in some embodiments, controller 120 may be placed in rear camera module 118.

In some embodiments, camera 106 may employ one or more stabilization techniques to stabilize its components. In some embodiments, camera 106 may employ a shock-absorbing coil or spring system around components of controller 120, such as the internal circuit board, or lens assembly. The shock-absorbing coil or spring system may be tuned to absorb minor shocks and vibrations encountered during normal use, such as, but not limited to, running, jumping, or handling camera 106 roughly. In some embodiments, the shock absorbing coil or spring system may take the form of a floating board design, where the printed circuit board and/or sensor assembly is suspended on a set of flexible membranes that allow subtle movement and deformation under stress, thus preventing direct transfer of shock energy to sensitive components of camera 106.

In some embodiments, camera 106 may employ a mechanical rotator mechanism to stabilize its components. In some embodiments, the mechanical rotator mechanism may incorporate a miniature gimbal-like assembly, such as an internal pivoting frame, which may enable the lens or sensors to rotate slightly along multiple axes. In some embodiments, the mechanical rotator mechanism may be controlled my micro-motors or servomotors to automatically adjust the camera angle to maintain level framing and reduce shake.

In some embodiments, camera 106 may employ a combination of electronic and mechanical stabilization elements to stabilize its components. For example, regardless of the type of mechanical system adopted for stabilizing components of camera 106, pairing the mechanical system with electronic image stabilization (EIS)_ or optical image stabilization (OIS) techniques may ensure maximum smoothness. For example, the mechanical stabilization system may handle larger, more pronounced movements, while the electronic stabilization system may refine the final image for subtler jitter. This multi-layered approach may provide backup stabilization if one system reaches its limits.

Controller 120 may be configured to provide end users with artificial intelligence driven functionalities that may allow end users to improve the quality of their video stream. In some embodiments, controller 120 may include video capture module 122, video enhancement module 124, voice command module 126, and battery manager 128. Each of video capture module 122, video enhancement module 124, voice command module 126, and/or battery manager 128 may be comprised of one or more software modules. The one or more software modules are collections of code or instructions stored on a media (e.g., memory of controller 120) that represent a series of machine instructions (e.g., program code) that implements one or more algorithmic steps. The machine instructions may be the actual computer code the processor of controller 120 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Video capture module 122 may be configured to stream or send video data in real-time or near real-time to a cloud environment, such as that executing across one or more computing systems associated with server system 104. In some embodiments, video capture module 122 may be configured to cause server system 104 to automatically save the video data in a cloud storage location. In this manner, camera 106 may function with its own built-in video hosting and sharing platform, providing users with seamless access to their recordings.

In some embodiments, video capture module 122 may be configured to dynamically optimize stream quality based on available bandwidth and user activity. For example, video capture module 122 may include one or more reinforcement learning models that are trained to adjust the quality of the livestream based on the amount of data that network 105 can handle when transferring the video content from camera 106 to server system 104. In some embodiments, video capture module 122 may be configured to dynamically optimize the stream based on the user activity.

For example, video capture module 122 may be configured to adjust video quality in real-time or near real-time based on a quality of available wireless connectivity. In operation, for example, video capture module 122 may be configured to monitor one or more parameters associated with a quality of available wireless connectivity. Exemplary parameters may include, but are not limited to network speed, stability, and data loss. In some embodiments, video capture module 122 may be configured to determine an amount of data loss by measuring one or more of latency (e.g., how quickly data is transmitted), jitter (e.g., stability), and throughput (e.g., how much data can flow).

In some embodiments, video capture module 122 may be configured to adjust video quality in real-time or near real-time based on a perceived activity. For example, video capture module 122 may be configured to interface with motion sensors (e.g., accelerometers, gyroscopes, etc.) of camera 106 to infer an activity of the user. In some embodiments, video capture module 122 may increase frame rate to achieve a smoother data capture. In some embodiments, video capture module 122 adjust the stabilization to achieve a smoother data capture. In another example, if video capture module 122 infers that the user is standing still, video capture module 122 may slightly reduce the quality to improve battery life and reduce the amount of data captured and/or transferred.

By being able to adjust video quality based on various factors such as quality of network availability and perceived activity, video capture module 122 may improve operation of camera 106 by ensuring that livestreaming does not lag or drop under a variety of external conditions.

In some embodiments, video capture module 122 may be configured operate camera 106 in continuous recording manner. For example, video capture module 122 may continuously record short clips of up to X minutes (e.g., up to five minutes) and then deletes footage older than X minutes. In this manner, video capture module 122 may function to capture unexpected moments the user may not have been prepared to record.

Video enhancement module 124 may be configured to enhance the video content streamed from camera 106. In some embodiments, video enhancement module 124 may include one or more generative adversarial networks (GANs) trained to provide end users with real-time video enhancement and upscaling functionalities. In some embodiments, video enhancement module 124 may be configured to enhance the streaming content through dynamic bitrate and quality adjustments, ensuring that high-quality video streams under variable network conditions. In some embodiments, video enhancement module 124 may be configured to improve the video content by making colors brighter, reducing noise, and sharpening details. For example, through the use of GANs. In this manner, video enhancement module 124 provides a technical improvement of on-prem editing and enhancement.

Voice command module 126 may be configured to support voice command functionality when capturing video data. In some embodiments, voice command module 126 may include a natural language processing module for voice command integration. Voice command module 126 may allow users to functionalities of camera 106 through verbal cues. For example, a user can instruct camera 106 to adjust a focal length of the lens to adjust the current zoom ratio for capturing video content. In operation for example, voice command module 126 may a command, such as “zoom in 1.5×.” Natural language processing module may analyze the natural language command and convert the natural language command into a computer instruction to cause controller 120 to adjust the focal length of the lens to achieve a 1.5× zoom.

Battery manager 128 may be configured to manage battery life of power source 119. In some embodiments, battery manager 128 may employ one or more predictive algorithms (e.g., time-series forecasting algorithms) to predict and manage life of camera 106. For example, in operation, battery manager 128 may gather data from one or more sensors of camera 106 in real-time or near real-time. In some embodiments, an example sensor may include a sensor that measures power draw from components of camera 106, such as, but not limited to the processor and/or wireless modules. In some embodiments, an example sensor may include a sensor that measures usage patterns based on the frequency of use of the camera (e.g., how long the user was streaming or recording data). In some embodiments, an example sensor may include a sensor that measures environment factors, such as temperature, which can affect battery efficiency. Based on the collected data, battery manager 128 may be configured to apply one or more machine learning models, such as time-series forecasting algorithms (e.g., ARIMA or LSTM networks), to predict an amount of battery life remaining. In some embodiments, battery manager 128 may utilize this output to prompt the user regarding how to improve battery efficiency. Using a specific example, if a user is recording continuously using a high-resolution setting, battery manager 128 may forecast that the user has thirty minutes remaining and may suggest that the user switch to a lower resolution to extend time.

In some embodiments, battery manager 128 may further be configured to employ one or more time-series forecasting algorithms to predict and manage storage space of camera 106. For example, battery manager 128 may monitor file sizes, a speed at which local storage is filling up, and whether cloud storage functionality is syncing. Based on this monitored information, battery manager 128 may utilize one or more machine learning models, such as time-series forecasting algorithms to predict when the user will run out of space. In some embodiments, battery manager 128 may provide the user with proactive notifications regarding the available file storage. In some embodiments, battery manager 128 may be configured to optimize storage space by automatically compressing files or uploading older recordings to free up local storage space while keeping that data accessible.

Highlight generation module 130 may be configured to automatically generate highlights based on video captured by camera 106. For example, highlight generation module 130 may be configured to store a predefined amount of video data over a predefined period of time. Based on the predefined amount of video data over the predefined period of time, highlight generation module 130 may identify portions of the video data corresponding to “highlight.” For example, highlight generation module 130 may analyze the video data and identify features such as lots of movement or specific gestures, or even audio spikes like cheering to identify those portions of the video data that are most engaging or garnered a threshold level of reaction. Using a specific example, assume that a user is filming a sports game - in this example, highlight generation module 130 may generate a highlight that includes a key goal or exciting play. To do so, during a livestream of the event, highlight generation module 130 may analyze content of the comments to the video to identify engaging moments. In some embodiments, highlight generation module 130 may score each moment and rank the moments by order of score, creating a highlight reel that includes those moments that exceed a threshold score level.

Server system 104 may be representative of one or more servers configured to communicate with one or more, such as user device 102, camera 106, and/or viewer computing systems 108. In some embodiments, server system 104 may be configured to host one or more virtualization elements (e.g., virtual machines or containers), such that components of server system 104 may be upscaled or downscaled, depending on demand or user request.

Server system 104 may include web client application server 114 and streaming system 132. Streaming system 132 may be representative of a streaming software that allows users to stream content captured using camera 106.

Streaming system 132 may include streaming enhancement module 134, object detection module 136, facial recognition module 138, and streaming module 140. Each of streaming enhancement module 134, object detection module 136, facial recognition module 138, and streaming module 140 may be comprised of one or more software modules. The one or more software modules are collections of code or instructions stored on a media (e.g., memory of server system 104) that represent a series of machine instructions (e.g., program code) that implements one or more algorithmic steps. The machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Streaming enhancement module 134 may be configured to enhance the streaming video before broadcast by streaming module 140. In some embodiments, streaming enhancement module 134 may include one or more machine learning processes to generate augmented overlays over the streaming content received from camera 106. In some embodiments, streaming enhancement module 134 may include one or more machine learning processes to generate closed captioning text for inclusion in the streaming video. In some embodiments, streaming enhancement module 134 may include one or more machine learning processes to translate audio content in the received video content and/or dub the audio content with the translated audio content based on requests from one or more viewer computing systems 108. In some embodiments, streaming enhancement module 134 may be configured to dub the user's voice in real-time using synthesized speech.

In some embodiments, streaming enhancement module 134 may use computer vision to track key elements in the video data, such as objects or places. In some embodiments, streaming enhancement module 134 may utilize one or more machine learning algorithms, such as You Only Look Once (YOLO), or other object detection models, to track key elements. Streaming enhancement module 134 may place overlays (e.g., labels or graphics) by mapping the overlays to the key elements in real-time. For example, during a livestream of a soccer game, streaming enhancement module 134 may identify and tag the ball and may cause display of the ball's perceived or measured speed on the display.

In some embodiments, streaming enhancement module 134 may generate real-time captions using one or more automatic speech recognition (ASR) models. These ASR models may break down the audio in the video content into phonemes (i.e., basic sound units) and may match them to words using a language module. In some embodiments, the captions may be displayed in synch with the video content. In some embodiments, the captions may be translated using one or more NLP frameworks.

In some embodiments, streaming enhancement module 134 may translate or dub the audio responsive to a request from a user using one or more machine translation models. In some embodiments, such as for dubbing, streaming enhancement module 134 may use text-to-speech (TTS) synthesis to create a voice in the target language, ensuring lip synchronization through audio processing techniques like time-stretching.

Object detection module 136 may be configured to detect objects in the video data received from camera 106. In some embodiments, object detection module 136 may include a convolutional neural network (e.g., ResNet, Mask R-CNN) trained to identify and/or classify objects within a video stream. For example, object detection module 136 may utilize the convolutional neural network to scan each video frame, and identify and classify objects within the video frame for the purpose of tagging or emphasizing certain detected objects in the video stream that is prepared and broadcasted to viewer computing systems 108. In some embodiments, object detection module 136 may be configured to differentiate between portions of the video data corresponding to the background and portions of the video data corresponding to the foreground. For example, to differentiate the subject (e.g., a person or an object of interest) from the background, object detection module 136 may be configured to apply semantic segmentation techniques by assigning pixels to specific categories (e.g., person, sky, grass, etc.) and mapping these regions onto the video. By differentiating between the background and foreground, object detection module 136 may enable streaming system 132 to replace the background in the video, insert augmented reality overlays, blue the background, and/or identify locations in the video stream to include closed captioning or translation data.

In some embodiments, object detection module 136 may be configured to predict the trajectories of objects in motion. In some embodiments, object detection module 136 may employ one or more algorithms, such as Kalman filters or optical flow analysis, to predict the trajectories. Such a process may ensure that overlays or effects (e.g., highlighting a basketball during while capturing a game) added by object detection module 136 stay locked onto the object of interest as it moves.

In some embodiments, object detection module 136 may feed the detected objects and their classifications into other modules, such as streaming enhancement module 134, which may use this data to apply effects or captions. For example, if object detection module 136 identifies a person speaking in the video content, object detection module 136 may interface with streaming enhancement module 134 to automatically generate captions for their dialogue.

In some embodiments, object detection module 136 may be configured to follow the detected object in a manner that provides end users with real-time object tracking. For example, for a given object (e.g., a ball), object detection module 136 may employ one or more vision algorithms to track the movement of the detected object across the frame. In some embodiments, such as when the object changes hands, object detection module 136 may be configured to automatically switch the feed from the current camera to another camera best positioned to capture the new holder or recipient.

To facilitate the object tracking functionality, object detection module 136 may employ one or more camera synchronization algorithms. The one or more camera synchronization algorithms may be configured to automatically switch which camera of multiple cameras is currently capturing the object being tracked. Automatic switching requires precise coordination between multiple cameras or camera angles.

In some embodiments, object detection module 136 may employ one or more algorithms that not only track the object's current position but predict its next position based on motion vectors and game context. Such functionality would be especially useful in fast-paced sports environments where the object (e.g., a ball) can move unpredictably.

In some embodiments, object detection module 136 may employ one or more infrared (IR) markers or patterns. For example, certain objects may be outfitted with IR reflectors or patterns not visible to the human eye but easily recognized by a dedicated IR sensor integrated into camera 106. This approach can enhance accuracy in varied lighting conditions.

In some embodiments, object detection module 136 may be configured to combine visual object tracking data with RF beacons or IR markers to ensure maximum robustness of object detection and tracking. If, for example, the vision-based AI loses sight of the object due to an obstruction or lighting issue, the RF/IR system serves as a fallback to maintain continuous tracking, thus increasing reliability and user confidence.

Facial recognition module 138 may be configured to detect and/or recognize faces of individuals in video content provided by camera 106. In some embodiments, facial recognition module 138 may include a convolutional neural network trained to identify faces of individuals through an active learning process. For example, an operator of camera 106 may dynamically tag individuals in the video data. The images of those individuals, along with the tags, may then be provided to a pre-trained convolutional neural network that is generally able to recognize faces in order to fine tune the convolutional neural network to recognize those tagged individuals in subsequent video content. In some embodiments, facial recognition module 138 may further include an emotional state classifier configured to classify an emotional state (e.g., happy, sad, surprised) of an individual in the video data. In some embodiments, facial recognition module 138 may employ one or more artificial intelligence techniques to analyze facial features, eye movements, or muscle activity to detect an individual's emotional state. In some embodiments, facial recognition module 138 may use the emotional state detection to automatically save portions of the video content where an individual is experiencing a certain emotional state (e.g., happy, surprised, sad).

In some embodiments, object detection module 136 and/or facial recognition module 138 may work in conjunction to detect an environment being captured based on the objects detected and/or the key subjects identified.

Streaming module 140 may be configured to package the video content with one or more enhancements generated by one or more of streaming enhancement module 134, object detection module 136, and/or facial recognition module 138. For example, streaming module 140 may stitch together closed captioning information with the video content when broadcasting the stream to viewer computing systems 108. In another example, streaming module 140 may dub the audio in the streaming content with translated audio when broadcasting the stream to viewer computing system 108. In another example, streaming module 140 may be configured to overlay tags or indicators that identify or label individuals in the streaming content provided to viewer computing system 108.

Viewer computing systems 108 may be representative of devices operated by viewers of streamed content. In some embodiments, viewer computing systems 108 may also be content creator devices, such as user device 102. Viewer computing system 108 may be representative of a mobile device, a tablet, a desktop computer, or any computing system having the capabilities described herein. Viewer computing system may include an application 150 executing thereon. Application 150 may be representative of an application associated with server system 104. For example, application 150 may be representative of a streaming application that provides the user the ability to view streams or livestreams of content. In some embodiments, application 150 may be a standalone application associated with server system 104, such as a mobile application, tablet application, desktop application, or, more generally, a software application affiliated with an entity associated with server system 104. In some embodiments, application 150 may be representative of a web browser configured to communicate with server system 104, such that an end user may gain access streams broadcast by server system 104 via a web browser. More generally, application 150 may be configured to provide an interface between user device 102 and server system 104 for the purpose of allowing a user to view streams generated by content creators. In some embodiments, application 150 may the same application as application 110. In such embodiments, application 150 and/or application 110 may include the same functionalities. In some embodiments, application 150 may be limited to viewing streams or livestreams.

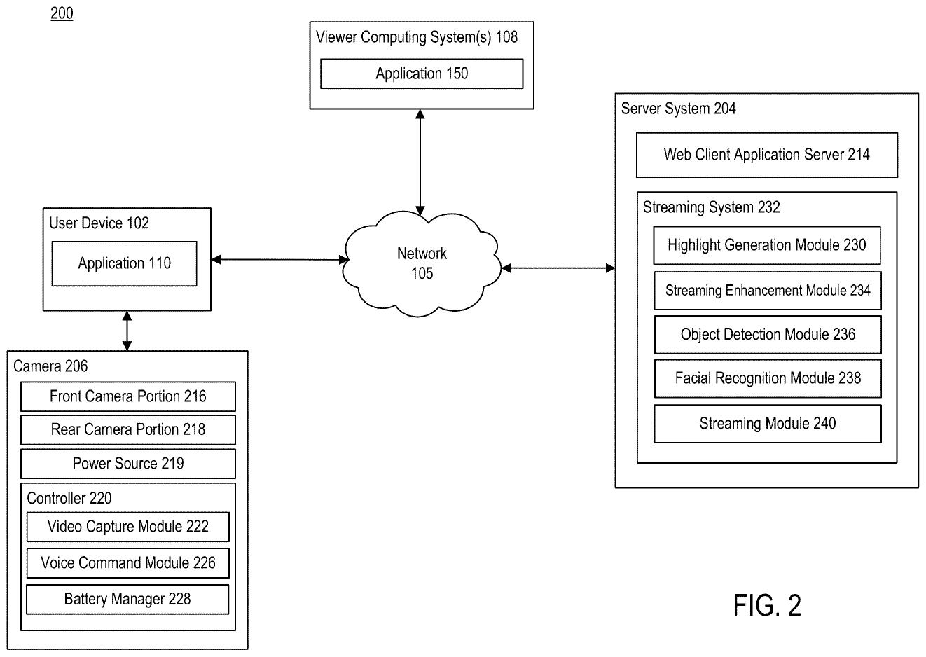

FIG. 2 is a block diagram illustrating computing environment 200, according to example embodiments. As shown, FIG. 2 may include the same basic components as computing environment 100. For example, computing environment 200 may include user device 102 and viewer computing systems 108. Computing environment 200 may further include server system 204 and camera 206. Computing environment 200 differs from computing environment 100 in that certain functionality performed by camera 106 may be moved to server system 204. By moving certain functionality from camera 106 to server system 204, camera 206 may be configurable to operate using a controller with less computing resources than in those embodiments in which functionality is performed on-device.

As shown, camera 206 may be constructed substantially similar to camera 106. For example, camera 206 may include a front camera module 216 substantially similar to front camera module 116 and a rear camera module 218 substantially similar to rear camera module 118. Rear camera module 218 may include power source 219 substantially similar to power source 119 and controller 220.

Controller 220 may be representative of a general-purpose computer configured to perform various processing capabilities described herein. Controller 220 may differ from controller 120 in that controller 220 may be representative of a general-purpose computer that has fewer computing resources or lower processing power than controller 120. To account for this certain processing may be moved from controller 220 to server system 104. For example, as shown, controller 120 may include video capture module 222, voice command module 226, and battery manager 228. Video capture module 222, voice command module 226, and battery manager 228 may be comprised of one or more software modules. The one or more software modules are collections of code or instructions stored on a media (e.g., memory of controller 220) that represent a series of machine instructions (e.g., program code) that implements one or more algorithmic steps. The machine instructions may be the actual computer code the processor of controller 220 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Voice command module 226 may be configured substantially similar to voice command module 126. Battery manager 228 may be configured substantially similar to battery manager 128. Video capture module 222 may be configured similar to video capture module 122. For example, video capture module 222 may be configured to stream or send video data in real-time or near real-time to a cloud environment, such as that executing across one or more computing systems associated with server system 204.

Server system 204 may be substantially similar to server system 104. For example, server system 204 may be representative of one or more servers configured to communicate with one or more, such as user device 102, camera 206, and/or viewer computing systems 108. In some embodiments, server system 204 may be configured to host one or more virtualization elements (e.g., virtual machines or containers), such that components of server system 204 may be upscaled or downscaled, depending on demand or user request.

Server system 204 may include web client application server 214 and streaming system 232. Streaming system 232 may be representative of a streaming software that allows users to stream content captured using camera 206.

Streaming system 232 may include highlight generation module 230, streaming enhancement module 234, object detection module 236, facial recognition module 238, and streaming module 240. Each of highlight generation module 230, streaming enhancement module 234, object detection module 236, facial recognition module 238, and streaming module 240 may be comprised of one or more software modules. The one or more software modules are collections of code or instructions stored on a media (e.g., memory of server system 204) that represent a series of machine instructions (e.g., program code) that implements one or more algorithmic steps. The machine instructions may be the actual computer code the processor of server system 204 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Highlight generation module 230, streaming enhancement module 234, object detection module 236, and facial recognition module 238 may be substantially similar to highlight generation module 130, streaming enhancement module 134, object detection module 136, and facial recognition module 138, respectively. Streaming module 240 may be substantially similar to streaming module 140 but may also include additionally functionality related to enhancing the video content received from camera 206 prior to broadcasting the video content to viewer computing systems 108. For example, streaming module 240 may include one or more GANs trained to provide real-time video enhancement and upscaling functionalities. In some embodiments, streaming module 240 may be configured to enhancing the streaming content through dynamic bitrate and quality adjustments, ensuring that high-quality video streams under variable network conditions.

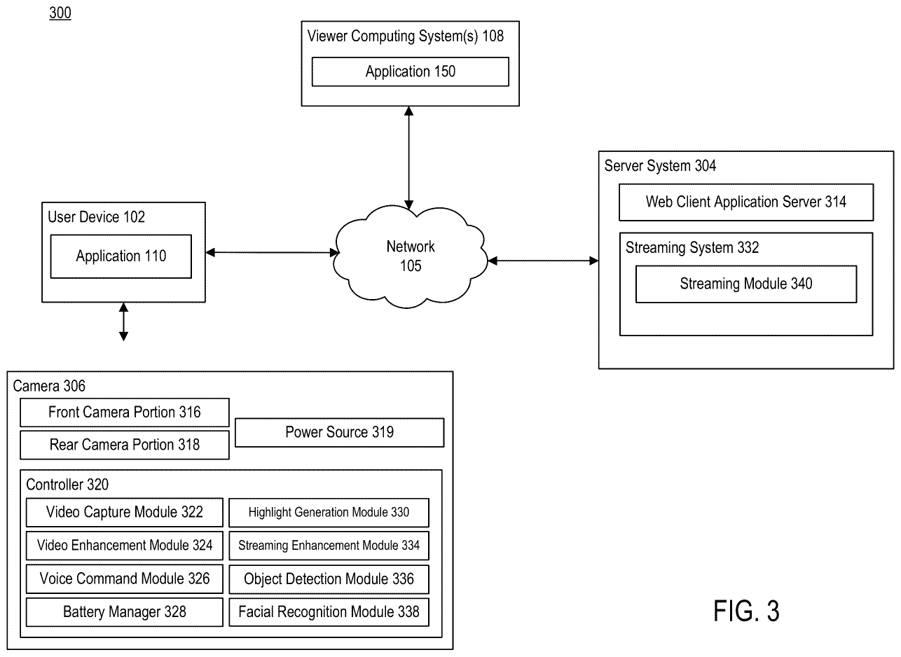

FIG. 3 is a block diagram illustrating computing environment 300, according to example embodiments. As shown, FIG. 3 may include the same basic components as computing environment 100. For example, computing environment 300 may include user device 102 and viewer computing systems 108. Computing environment 300 may further include server system 304 and camera 306. Computing environment 300 differs from computing environment 300 in that certain functionality performed by server system 104 may be moved to camera 306. By moving certain functionality from server system 104 to camera 306, the lag between the video data being captured by camera 306 and the time that server system 304 broadcasts the processed video data may be reduced due to improved on-device performance.

As shown, camera 306 may be constructed substantially similar to camera 106. For example, camera 306 may include a front camera module 316 substantially similar to front camera module 116 and a rear camera module 318 substantially similar to rear camera module 118. Rear camera module 318 may include power source 319 substantially similar to power source 119 and controller 320.

Controller 320 may be representative of a general-purpose computer configured to perform various processing capabilities described herein. Controller 320 may include video capture module 322, video enhancement module 324, voice command module 326, battery manager 328, highlight generation module 330, streaming enhancement module 334, object detection module 336, and facial recognition module 338. Video capture module 322, voice command module 326, battery manager 328, highlight generation module 330, streaming enhancement module 334, object detection module 336, and facial recognition module 338 may be comprised of one or more software modules. The one or more software modules are collections of code or instructions stored on a media (e.g., memory of controller 320) that represent a series of machine instructions (e.g., program code) that implements one or more algorithmic steps. The machine instructions may be the actual computer code the processor of controller 320 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Video enhancement module 324 may be configured substantially similar to video enhancement module 124. Voice command module 326 may be configured substantially similar to voice command module 126. Battery manager 328 may be configured substantially similar to battery manager 128. Highlight generation module 330 may be configured substantially similar to highlight generation module 130. Object detection module 336 may be substantially similar to object detection module 136. Facial recognition module 338 may be substantially similar to facial recognition module 138.

Streaming enhancement module 334 may be configured similar to streaming enhancement module 134. For example, streaming enhancement module 334 may be configured to enhance the video content before sent by camera 306 to server system 304 for distribution. In some embodiments, streaming enhancement module 334 may include one or more machine learning processes to generate augmented overlays over the video content captured by camera 306. In some embodiments, streaming enhancement module 334 may include one or more machine learning processes to generate closed captioning text for inclusion with the video content. In some embodiments, streaming enhancement module 334 may include one or more machine learning processes to translate audio content in the received video content and/or dub the audio content with the translated audio content based on requests from one or more viewer computing systems 108.

Video capture module 322 may be configured similar to video capture module 122. For example, video capture module 322 may be configured to stream or send video data in real-time or near real-time to a cloud environment, such as that executing across one or more computing systems associated with server system 304. Video capture module 322 may further be configured to send, with the video content, additional data generated by one or more of object detection module 336, facial recognition module 338, and/or streaming enhancement module 334.

In some embodiments, because object detection module 336 and facial recognition module 338 execute locally, video capture module 122 may leverage their outputs to further enhance camera's 106 functionality. For example, if facial recognition module 338 identifies a key subject in the video data, video capture module 122 may be configured to dynamically zoom in on the key subject. In another example, based on the scene or environment that object detection module 336 and facial recognition module 338 identify, video capture module 122 may adjust the parameters of camera 106 (e.g., flash on in low light environments). In another example, based on an inferred activity of the user that object detection module 336 and facial recognition module 338 identify, video capture module 122 may adjust the parameters of camera 106 (e.g., no flash when capturing a football game). In another example, video capture module 122 may activate camera 106 to begin capturing video data when facial recognition module 338 detects an individual in a happy state.

Server system 304 may be substantially similar to server system 104. For example, server system 304 may be representative of one or more servers configured to communicate with one or more, such as user device 102, camera 306, and/or viewer computing systems 108. In some embodiments, server system 304 may be configured to host one or more virtualization elements (e.g., virtual machines or containers), such that components of server system 304 may be upscaled or downscaled, depending on demand or user request.

Server system 304 may include web client application server 314 and streaming system 332. Streaming system 332 may be representative of a streaming software that allows users to stream content captured using camera 206. Streaming system 332 may include streaming module 340. streaming module 340 may be comprised of one or more software modules. The one or more software modules are collections of code or instructions stored on a media (e.g., memory of server system 304) that represent a series of machine instructions (e.g., program code) that implements one or more algorithmic steps. The machine instructions may be the actual computer code the processor of server system 304 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Streaming module 340 may be substantially similar to streaming module 140. For example, streaming module 340 may be configured to broadcast the packaged video and data content received from camera 306 to viewer computing systems 108.

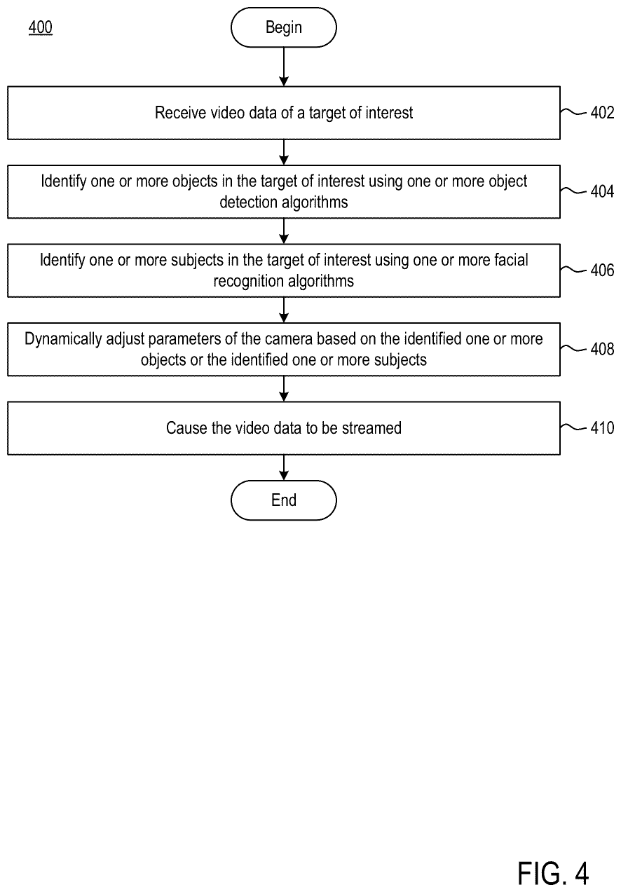

FIG. 4 is a flow diagram illustrating a method 400 of streaming video content, according to example embodiments. Method 400 may begin at step 402.

At step 402, a controller of a camera may receive video data of a target of interest.

At step 404, the controller may identify one or more objects in the target of interest using one or more object detection algorithms. For example, the controller may employ a convolutional neural network trained to identify objects in the video data.

At step 406, the controller may identify one or more subjects in the target of interest using one or more facial recognition algorithms. For example, controller may employ a convolutional neural network trained to detect faces in the video data. In some embodiments, the controller may further employ an emotional state model to determine a perceived emotional state of the one or more subjects in the video data.

At step 408, the controller may dynamically adjust parameters of the camera based on the identified one or more objects and/or the identified one or more subjects. For example, controller may adjust the focal length of the lens of the camera in order to focus on an identified object or subject. In some embodiments, controller may cause the camera to focus on an identified subject based on a perceived emotional state of the identified subject.

At step 410, the controller may cause the video data to be streamed. For example, the video data may include data captured before and after the parameter adjustment.

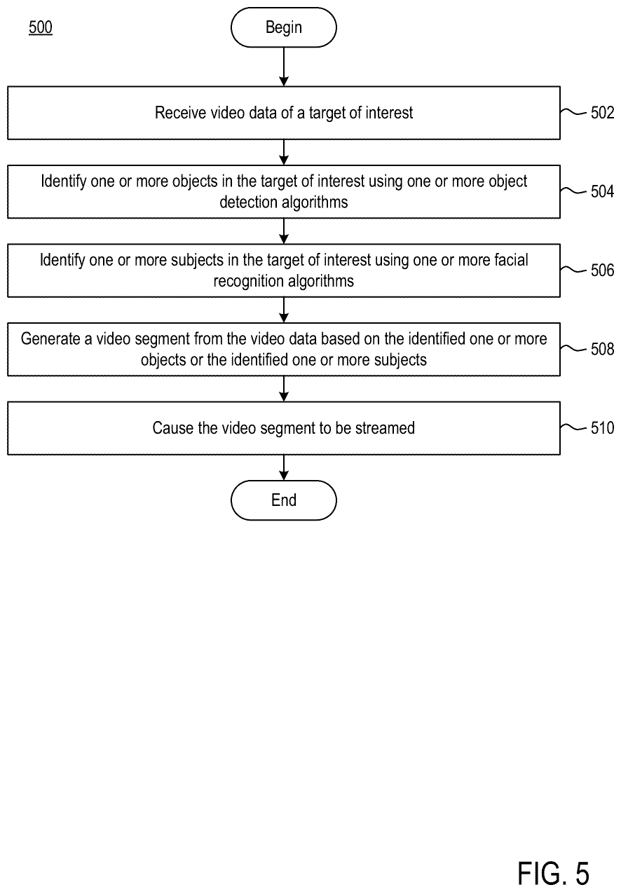

FIG. 5 is a flow diagram illustrating a method 500 of streaming video content, according to example embodiments. Method 500 may begin at step 502.

At step 502, a controller of a camera may receive video data of a target of interest.

At step 504, the controller may identify one or more objects in the target of interest using one or more object detection algorithms. For example, the controller may employ a convolutional neural network trained to identify objects in the video data.

At step 506, the controller may identify one or more subjects in the target of interest using one or more facial recognition algorithms. For example, controller may employ a convolutional neural network trained to detect faces in the video data. In some embodiments, the controller may further employ an emotional state model to determine a perceived emotional state of the one or more subjects in the video data.

At step 508, the controller may generate a video segment from the video data based on the identified one or more objects and the identified one or more subjects. For example, controller may generate a highlight segment based on an analysis over the video data over a predefined period of time. Based on the analysis, the controller may select those portions of the video data that has a higher perceived importance relative to the remaining portions of the video data. In some embodiments, a portion of video data may have a higher perceived importance relative to another portion of the video data based on the objects, subjects, or emotions identified in the portion of video data.

At step 510, the controller may cause the highlight to be streamed. For example, controller may transmit the highlight to streaming platform for distribution.

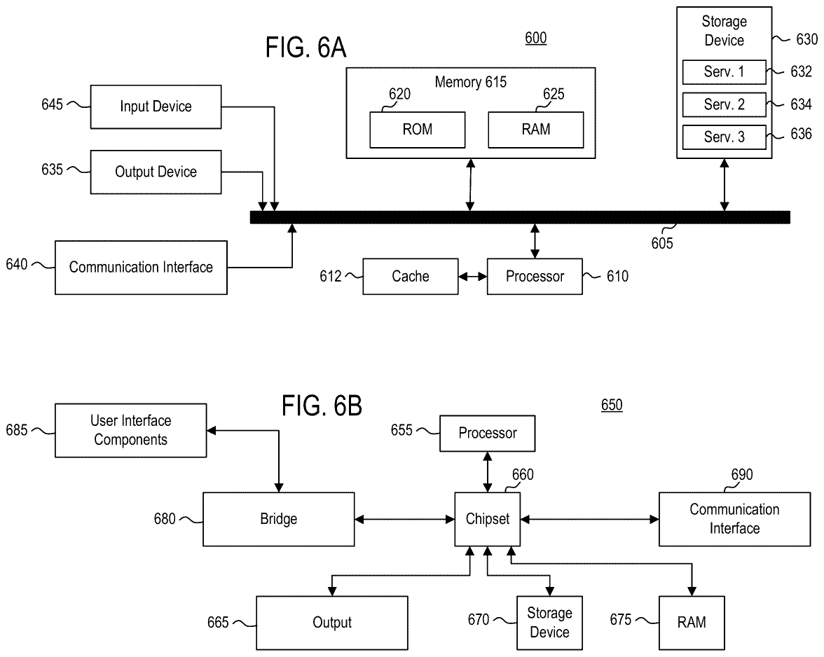

FIG. 6A illustrates a system bus architecture of computing system 600, according to example embodiments. System 600 may be representative of at least user device 102, server system 104, controller 120, or viewer computing system 108. One or more components of system 600 may be in electrical communication with each other using a bus 605. System 600 may include a processing unit (CPU or processor) 610 and a system bus 605 that couples various system components including the system memory 615, such as read only memory (ROM) 620 and random-access memory (RAM) 625, to processor 610.

System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general-purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635 (e.g., display), and so forth, to carry out the function.

FIG. 6B illustrates a computer system 650 having a chipset architecture that may represent user device 102, server system 104, controller 120, or viewer computing system 108. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655.

In this example, chipset 660 outputs information to output 665, such as a display, and may read and write information to storage device 670, which may include magnetic media, and solid-state media, for example. Chipset 660 may also read data from and write data to storage device 675 (e.g., RAM). A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or storage device 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A camera system, comprising:
a camera configured to capture video data comprising:
a front facing camera portion comprising a lens, and
a rear facing camera portion configured to be selectively coupled with front facing camera via one or more coupling mechanisms, and:
a controller configured to communicate with a streaming platform, the controller comprising:
a video capture module configured to dynamically optimize transmission quality of the video data based on perceived bandwidth between the controller and the streaming platform; and
a voice command module configured to receive natural language commands and execute one or more actions to control capture of the video data based on the natural language commands.

2. The camera system of claim 1, wherein the video capture module is further configured to dynamically optimize the transmission quality of the video data based on a detected activity.

3. The camera system of claim 1, wherein the one or more actions comprises an adjustment to a focal length of the lens.

4. The camera system of claim 1, wherein the controller further comprises:
a battery manager configured to manage a battery life of a power source associated with the controller.

5. The camera system of claim 1, wherein the controller further comprises:
a highlight generation module configured to automatically generate a video segment from the video data.

6. The camera system of claim 1, wherein the controller further comprises:
a closed captioning module configured to generate closed captioning text for inclusion in a stream of the video data.

7. The camera system of claim 1, wherein the controller further comprises:
a translation module configured to dub audio content of the video data in real-time or near real-time for inclusion in a stream of the video data.

8. The camera system of claim 1, wherein the controller further comprises:
a facial recognition module configured to identify one or more subjects present in the video data.

9. The camera system of claim 8, wherein the facial recognition module is further configured to detect an emotional state of a subject of the one or more subjects.

10. The camera system of claim 8, wherein the controller further comprises:
an object recognition module configured to identify one or more objects present in the video data.

11. The camera system of claim 10, wherein the object recognition module and the facial recognition module work in conjunction to identify an environment in the video data.

12. A camera system, comprising:
a camera comprising:
a front facing camera portion comprising a lens,
a rear facing camera portion configured to be selectively coupled with front facing camera via one or more coupling mechanisms, and
a controller configured to perform operations comprising:
receiving video data of a target of interest,
identifying one or more objects in the target of interest using one or more object detection algorithms,
identifying one or more subjects in the target of interest using one or more facial recognition algorithms, and
dynamically adjusting parameters of the camera based on the identified one or more objects and the identified one or more subjects.

13. The camera system of claim 12, wherein dynamically adjusting the parameters of the camera based on the identified one or more objects and the identified one or more subjects comprises:
determining, based on the one or more identified objects and the one or more identified subjects an environment comprising the target of interest, wherein the parameters are adjusted based on the determined environment.

14. The camera system of claim 12, wherein dynamically adjusting the parameters of the camera based on the identified one or more objects and the identified one or more subjects comprises:
determining, based on the one or more identified objects and the one or more identified subjects an activity occurring in the target of interest, wherein the parameters are adjusted based on the determined activity.

15. The camera system of claim 12, further comprising:
analyzing faces of the one or more subjects to determine an emotional state of the subject.

16. The camera system of claim 15, further comprising:
dynamically adjusting parameters of the camera based on the identified one or more objects and the identified one or more subjects.

17. The camera system of claim 12, further comprising:
causing the video data to be streamed to a plurality of viewer computing systems by transmitting the video data and information associated with the one or more identified subjects and the one or more identified objects to a streaming platform.

18. The camera system of claim 17, further comprising:
adjusting a rate at which the video data is transmitted to the streaming platform based on a perceived network strength between the controller and the streaming platform.

19. A camera system, comprising:
a camera comprising:
a front facing camera portion comprising a lens,
a rear facing camera portion configured to be selectively coupled with front facing camera via one or more coupling mechanisms, and
a controller configured to perform operations comprising:
receiving video data of a target of interest,
identifying one or more objects in the target of interest using one or more object detection algorithms,
identifying one or more subjects in the target of interest using one or more facial recognition algorithms, and
generating a video segment from the video data based on the identified one or more objects and the identified one or more subjects.

20. The camera system of claim 19, wherein generating the video segment from the video data based on the identified one or more objects and the identified one or more subjects comprises:
analyzing the video data to identify portions of the video data that include one or more of the one or more objects or the one or more subjects.
